(19) United States
(12) Patent Application Publication
(10) Pub. No.: US 2021/0143666 A1
(43) Pub. Date: May 13, 2021

(54) BATTERY CHARGING IN INTEGRATED-STARTER GENERATORS

(71) Applicant: INDIA NIPPON ELECTRICALS LIMITED, Hosour (IN)

(72) Inventors: Raman UMASHANKAR, HOSUR (IN); Bose SENTHILVALAVAN, Hosur (IN)

(21) Appl. No.: 16/623,179

(22) PCT Filed: Nov. 20, 2018
(86) PCT No.: PCT/IN2018/050767

§ 371 Date: Dec. 16, 2019

(30) Foreign Application Priority Data
Nov. 20, 2017 (IN) 201741041574

(51) Int. Cl. H02J 7/24; H02J 7/00

(52) U.S. Cl. CPC H02J 7/24; H02J 7/007182; H02J 7/0048

(57) ABSTRACT

An Integrated Starter-Generator (ISG) comprises a series regulator. The series regulator includes a controllable switch to be connected to a terminal of an electrical machine to receive an AC voltage from the electrical machine and to be connected to a battery to supply charging current to the battery in response to actuation of the controllable switch. The series regulator further includes a controller connected to the controllable switch to provide an actuating signal to actuate the controllable switch. The controller is configured to monitor a voltage level of the battery and determine whether to provide the actuating signal to the controllable switch based on the voltage level of the battery.

### TECHNICAL FIELD

The present subject matter relates, in general, to integrated starter-generators and, in particular, to battery charging in integrated starter-generators.

### BACKGROUND

An Integrated Starter-Generator (ISG) is used in an automobile for starting an engine, such as internal combustion engine of the automobile in a motoring mode and for providing electrical power to electrical loads of the automobile in a generator mode. During starting, a battery acts as an energy source and provides a Direct Current (DC) voltage that is inverted into an Alternating Current (AC) voltage and fed to an electrical machine of the ISG. The electrical machine then acts as an electric motor for cranking the engine. After the engine has started, the ISG acts in the generator mode, and provides an AC voltage, which is then rectified and used to charge the battery.

### BRIEF DESCRIPTION OF DRAWINGS

The features, aspects, and advantages of the present subject matter will be better understood with regard to the following description, and accompanying figures. The use of the same reference number in different figures indicates similar or identical features and components.

FIG. 1 illustrates an Integrated Starter Generator (ISG), in accordance with an implementation of the present subject matter.

FIG. 2 illustrates the ISG, in accordance with an implementation of the present subject matter.

FIG. 3 illustrates pulses generated by a comparator based on signals from a voltage of a battery and a second control block, in accordance with an implementation of the present subject matter.

FIG. 4 illustrates a method for controlling charging of a battery by an integrated starter generator, in accordance with an implementation of the present subject matter.

### DETAILED DESCRIPTION

Integrated Starter-Generators (ISGs) perform both the functions of starting an engine of an automobile in the motoring mode and providing power to electrical loads of the automobile in a generator mode. During starting of the automobile, the ISG acts in a motoring mode for cranking the engine. After the automobile has started and is running at a higher speed, the ISG acts as a generator, and converts the mechanical energy from a shaft of the engine into electrical energy for charging a battery of the automobile.

Generally, an ISG includes an electrical machine that acts as a motor or a generator, one or more Hall sensors to sense position of a rotor of the electrical machine, and a bridge circuit that can act as a rectifier or inverter. The bridge circuit has a plurality of switches, such as metal-oxide-semiconductor field-effect transistors (MOSFETs). Further, the ISG includes a bridge driver for driving the switches of the bridge circuit.

In a motoring mode, i.e., when the ISG is used to start the engine, the bridge driver receives an input from the one or more hall sensors indicative of the rotor position. Based on the rotor position, the bridge driver controls the switches in the bridge circuit such that the bridge circuit acts as an inverter, and converts a Direct Current (DC) voltage from a battery into an Alternating Current (AC) voltage. The AC voltage is then fed to the electrical machine, which then acts as an electric motor for cranking the engine.

When the starting is complete and the engine has picked up speed, the electrical machine acts as a generator and generates an AC voltage, which is then fed to the bridge circuit. The bridge circuit then acts as a rectifier, and provides a rectified output voltage for charging the battery and for power electrical loads, such as lights. When speed of the electrical machine increases, the AC voltage also increases, which, in turn, increases the battery voltage. To maintain the battery voltage within an acceptable level, the bridge driver switches on some of the switches in the bridge circuit such that the voltage of the battery remains within the acceptable level. This causes shunting of the windings of the electrical machine. Shunting causes heat generation in the windings, leading to a reduction in efficiency of the ISG. During this shunting, the internal inductance of the windings of the electrical machine limit the shunting current and to a maximum limit so that the battery voltage under charged condition is not exceeded.

The present subject matter relates to battery charging in integrated starter-generators (ISGs). With the present subject matter, the voltage of the battery is maintained within an acceptable level and the efficiency of battery charging in ISGs is considerably increased with the inclusion of additional power switches and control of these additional switches.

In an implementation of the present subject matter, an ISG includes a series regulator between AC terminals from an electrical machine and a battery. The series regulator includes a controllable switch and a diode connected to an AC terminal of the electrical machine. The controllable switch, may be, for example, a power semiconductor device, such as a silicon controlled rectifier (SCR). The controllable switch is to receive an AC voltage from the electrical machine and to supply charging current to the battery in response to an actuation of the controllable switch. The series regulator also includes a controller. The controller is connected to the controllable switch to provide an actuating signal to actuate the controllable switch. The controller is configured to monitor a voltage level of the battery and to determine whether to providing the actuating signal to the controllable switch based on the voltage level of the battery.

The present subject matter enables regulating charging of battery by the ISG using a series regulator between the AC terminals of the electrical machine and the battery. This eliminates shunting windings of the electrical machine, thereby preventing generation of heat and loss of efficiency.

The above and other features, aspects, and advantages of the subject matter will be better explained with regard to the following description, and accompanying figures. It should be noted that the description and figures merely illustrate the principles of the present subject matter along with examples described herein and, should not be construed as a limitation to the present subject matter. It is thus understood that various arrangements may be devised that, although not explicitly described or shown herein, embody the principles of the present disclosure. Moreover, all statements herein reciting principles, aspects, and examples thereof, are intended to encompass equivalents thereof. Further, for the sake of simplicity, and without limitation, the same numbers are used throughout the drawings to reference like features and components.

FIG. 1 illustrates an integrated starter-generator (ISG) 100, in accordance with an implementation of the present subject matter.

The ISG 100 includes an electrical machine (not shown in FIG. 1) that can act as a motor or a generator. The electrical machine may be a three-phase machine, and may be connected to the Alternating Current (AC) terminals 102, 104, and 106, corresponding to the three phases. The ISG 100 also includes a bridge circuit 108. The bridge circuit 108 can be connected to the terminal of the electrical machine and to a battery 116. The bridge circuit 108 includes a plurality of switches. The switches may include power semiconductor devices, such as metal-oxide-semiconductor field-effect transistors (MOSFETs). Each switch may also include a diode, also known as a body diode, connected across the corresponding power semiconductor device for conducting reverse current.

In an implementation, for the three phase AC supply, six switches are provided, such as 110-1, 110-2, . . . , 110-6. The switches 110-1, 110-2, . . . , 110-6 of the bridge may be collectively referred to as bridge switches 110. Although the power semiconductor devices are explained herein with reference to MOSFETs, it will be understood that any other type of power semiconductor devices may also be used in the bridge circuit 108.

Each of the bridge switches 110-1 to 110-6 may be connected to a driver 112 to control the switching of the bridge switches 110. For this, the driver 112 may be connected to the gate terminals of the MOSFETs of the bridge switches 110. The driver 112 may be provided as an integrated circuit (IC), and may be referred to as a driver IC 112. The driver 112 may control the bridge switches 110 based on a signal indicative of a rotor position of the electrical machine from a sensor system 114. The sensor system 114 may include one or more Hall sensors.

During the starting of an engine (not shown in FIG. 1) that includes the ISG 100, the ISG 100 operates in a motoring mode for cranking the engine. For this, the sensor system 114 produces an output based on the rotor position of the electrical machine. The output from sensor system 114 is received by the driver 112. Based on the output of the sensor system 114, the driver 112 controls the MOSFETs in the bridge circuit 108 such that the bridge circuit 108 receives a Direct Current (DC) voltage from the battery 116, generates Alternating Current (AC) voltage, and supplies the generated AC voltage to the terminal of the electrical machine. This AC voltage enables the electrical machine to act as an electric motor and crank the engine.

After the engine has started and has reached a certain speed, the ISG 100 functions as a generator, interchangeably referred to as an alternator, and generates an AC voltage. This AC voltage can be used to for charging a battery 116 of a vehicle including the ISG 100. When the ISG 100 operates in the generating mode, the AC voltage generated by the electrical machine is available across its terminals, also referred to as the AC terminals 102, 104, and 106. This AC voltage is supplied to a series regulator 118. The series regulator 118 includes a controllable switch and a diode connected to an AC terminal of the electrical machine. The controllable switch may be, for example, a silicon controlled rectifier (SCR), interchangeably referred to as a thyristor. When the electrical machine of the ISG 100 is a three phase machine, the series regulator 118 may include three controllable switches, as will be explained below. The controllable switch is to receive an AC voltage from the electrical machine and to supply charging current to the battery in response to an actuation of the controllable switch. The ISG also includes a controller 132. The controller 132, amongst other capabilities, may be configured to fetch and execute instructions. The controller 132 may be implemented as one or more microprocessors, microcomputers, microcontrollers, digital signal processors, central processing units, state machines, logic circuitries, and/or any devices that manipulate signals based on operational instructions.

The controller 132 is connected to the controllable switch to provide an actuating signal to actuate the controllable switch. The controller 132 is configured to monitor a voltage level of the battery and for to determine whether to providing the actuating signal to the controllable switch based on the voltage level of the battery 116. Further, a diode is connected to the controller 132 to power the controller 132. The provision of actuating signal to the controllable switch may be interchangeably referred to as triggering the controllable switch or turning on the controllable switch.

In a three-phase electrical machine, for example, the series regulator 118 can include three sets of controllable switch and diode: a first controllable switch 120 and a first diode 122 connected to each other and forming a first set, a second controllable switch 124 and a second diode 126 connected to each other and forming a second set, and a third controllable switch 128 and a third diode 130 connected to each other and forming a third set. The first controllable switch 120 is connected to the AC terminal 102, the second controllable switch 124 is connected to the AC terminal 104, and the third controllable switch 128 is connected to the AC terminal 106. Similarly, the first diode 122 is connected to the AC terminal 102, the second diode 126 is connected to the AC terminal 104, and the third diode 130 is connected to the AC terminal 106.

Although the controllable switch of the series regulator 118 is explained herein with reference to a thyristor, it is to be understood that any other type of power semiconductor device, such as a power MOSFET, can be used as well. Hereinafter, the terms controllable switch and thyristor will be used interchangeably.

In an implementation, the anode terminal of a thyristor in a set of the series regulator 118 is connected to the anode terminal of the diode in the set, as shown in FIG. 1. Also, the AC terminal corresponding to a set is connected to the anode terminals of the thyristor and the diode, as shown in FIG. 1. Further, the cathode terminals of the thyristors 120, 124, and 128 are connected to the positive terminal of the battery 116. Still further, the gate terminal of each of the thyristors 120, 124, and 128 is connected to a controller 132 that can control switching of the thyristors. The controller 132 can be powered using a rectified AC voltage provided by the diodes 122, 126, and 130. For this, the cathode terminals of the diodes 122, 126, and 130 may be connected to the controller 132 and internally stepped down (not illustrated in FIG. 1) in voltage to a level that is sufficient to provide controlled power to the controller 132.

In an implementation, during the generating mode of the ISG 100, the bridge circuit 108 is prevented from charging the battery 116, and the battery 116 is charged through the series regulator 118 alone. For this, the ISG 100 can include a reverse connected series diode 134 between the bridge circuit 108 and the battery 116. Alternatively, a MOSFET whose gate terminal is kept deactivated and the body diode is used as the series diode 134. The anode terminal of the series diode 134 is connected to the battery 116 and the cathode terminal of the series diode 134 is connected to the bridge circuit 108. This enables the conduction of the current from the battery 116 to the bridge circuit 108 during the motoring mode alone, and not during the generating mode. Further, during the generating mode, the driver 112 may turn off all MOSFETs of the bridge circuit 108.

The provision of the series regulator 118 and the series diode 134 ensures that the bridge circuit 108 operates only during the motoring mode, i.e., as an inverter alone. Therefore, the bridge circuit 108 is operated for a lesser amount of time. This can increase the lifetime of the bridge circuit 108.

During the generating mode, the AC voltage available at the AC terminals 102, 104, and 106 is present across the anode terminals of the thyristors and diodes of the series regulator 118. In an example, the actuating signal can be a gating signal to a thyristor. The controller 132 provides an actuating signal to actuate the controllable switch when the AC voltage generated at the terminal of the electrical machine is at a positive half cycle. Therefore, when the controller 132 provides the actuating signal to the controllable switch, the controllable switch turns on and conducts during the positive half cycle of the AC available at its anode terminal to the battery 116, thereby supplying charging current to the battery 116, and charging the battery 116. For example, when the controller 132 provides the actuating signal to the first controllable switch 120, a positive half cycle of the phase voltage at the AC terminal 102 is provided to the battery 116 for its charging. When the phase voltage at the AC terminal 102 moves to a negative half cycle, the first controllable switch 120 turns off since the current tends to drop to zero, thereby stopping charging of the battery 116. Therefore, by providing actuating signals to the controllable switches 120, 124, and 128, the controller 132 can control the charging of the battery 116 from each of the three phases in sequence. Further, the controller 132 may also delay triggering of, i.e., providing actuating signal, a controllable switch during the positive half cycle of its corresponding phase voltage to control the time for which the battery 116 is charged during the positive half cycle and control the energy fed in the conducting time of the controllable switches. This, in turn, controls charging of the battery 116.

In an implementation, the controller 132 provides actuating signals to the controllable switches 120, 124, and 128 based on the voltage level of the battery 116. For example, when the voltage of the battery 116 is lower than a first predetermined threshold, the controller 132 provides actuating signals to the thyristors 120, 124, and 128, thereby enabling charging of the battery 116. In an implementation, when the voltage of the battery 116 exceeds a second predetermined threshold, the controller 132 may stop triggering the thyristors 120, 124, and 128, thereby preventing further charging of the battery 116.

By regulating the charging of the battery 116 based on the voltage level of the battery 116, the controller 132 ensures that the voltage of the battery 116 is maintained in a predetermined range.

In an implementation, the controller 132 can provide the actuating signals based on the generated AC voltage as well. The controller can provide the actuating signal to the controllable switch for charging the battery 116, based on whether the AC voltage generated at the terminal of the electrical machine is lesser than a third predetermined threshold voltage. For example, when the generated AC voltage is lesser than a third predetermined threshold, the controller may provide gating signals to the thyristors 120, 124, and 128. When the generated AC voltage is greater than the third predetermined threshold, the controller 132 may not provide gating signals to the thyristors 120, 124, and 128. The charging of the battery by way of monitoring the generated AC voltage ensures that the actuating signals are provided only when the voltage level of the battery 116 falls below a certain threshold value. This is because the generated AC voltage can be directly correlated to the voltage level of the battery 116.

The controller 132 may provide gating signals to all the thyristors 120, 124, and 128 simultaneously, thereby turning on all of them. Since the cathode terminals of all the thyristors 120, 124, and 128 are connected to each other and to the battery 116, the thyristor whose anode that has the highest instantaneous voltage in the sinusoidal waveform provides the charging current for the battery 116. In another implementation, the controller 132 may provide gating signals to different thyristors at different points of time. For example, the controller 132 may provide a gating signal to the thyristor 120 when the AC phase voltage available at the AC terminal 102 is at a positive half cycle. Further, the controller 132 may regulate charging of the battery 116 based on the actuating signal by delaying triggering of the controllable switch to control a time for which the battery is charged. In an example, the controller 132 may delay the triggering of a thyristor during the positive half cycle of the corresponding phase voltage to regulate the time for which the battery 116 will charge. For example, the controller 132 may not immediately turn on the thyristor 120 when the phase voltage at the AC terminal 102 starts a positive half cycle.

FIG. 2 illustrates the ISG 100, in accordance with an implementation of the present subject matter. The controller 132 includes a first control block 202 and a second control block 204. The second control block 204 generates a signal which is indicative of the rotor position of the electrical machine and thereby also indicative of the speed of the rotor of the electrical machine. The signal indicative of the rotor position of the electrical machine is provided as an input to the first control block 202. Another input signal which is indicative of the voltage level of the battery 116, is provided to the first control block 202. Based on the inputs from the second control block 204 and the voltage level of the battery 116, the first control block 202 provides actuating signals to the thyristors 120, 124, and 128. In an example, the first control block 202 can be a comparator, and may be referred to as the comparator 202. In an implementation, the comparator 202 functions as an AND gate and provides actuating signals to the controllable switches 120, 124, and 128 when the inputs from both the battery 116 and the second control block 204 are high.

The operation of the first control block 202 is explained below with reference to FIG. 3.

FIG. 3 illustrates pulses generated by the first control block 202 based on the signals from the battery 116 and the second control block 204, in accordance with an implementation of the present subject matter.

Waveforms 302, 304, and 306 illustrate the three phase voltages generated by the electrical machine in the generating mode, available at the AC terminals 102, 104, and 106, respectively. The mono-stable pulses, of a predetermined width, 308-1, 308-2, 308-3, . . . are generated by a first Hall sensor of the sensor system 114. Similarly, the pulses 310-1, 310-2, 310-3, . . . are generated by a second Hall sensor and the pulses 312-1, 312-2, 312-3, . . . are generated by a third Hall sensor of the sensor system 114. The sensor systems may include other sensor systems such as inductive sensors, optical sensors, or other magnetic sensors.

Pulse stream 314 includes mono-stable, low-width pulses generated at a rising or a falling edge of each of the Hall sensor output, i.e., 308-1, 308-2, 308-3, . . . , 310-1, 310-2, 310-3, . . . , 312-1, 312-2, 312-3, . . . . using the ORing function so that the pulse stream is made of all the rising and falling edges of the three sensors. This is illustrated by the reference numeral 314 which links specific pulses to the respective edges of the sensor signal. The pulse stream 314 is generated by the second control block 204 based on the Hall sensor output which is indicative of the position of the rotor of the electrical machine. Further, the pulse stream 316 includes pulses indicative of the voltage level of the battery 116. The pulse stream 316 is formed when the battery voltage decreases lesser than a threshold. Contrarily, when voltage of the battery 116 indicates that it is fully charged, no pulses are generated.

The first control block 202 receives the pulse stream 314 and pulse stream 316 as inputs and generates pulses when both the inputs are high, as illustrated by pulse stream 318. The pulse stream 318 is provided as gating signals to the thyristors 120, 124, and 128, for controlling their turn on. Although the first control block 202 is shown to generate a single pulse stream 318, in an implementation, the first control block 202 can generate different pulse streams corresponding to different thyristors.

The comparison of the pulse stream 314 and the pulse stream 316 by the comparator 202 for generating the actuating signals prevents frequent triggering of the controllable switches 120, 124, and 128. This, in turn, may limit the peak current that is supplied to the battery 116.

The number of pulses generated by the second control block 204 can be reduced as the battery voltage nears the maximum voltage and thus the thyristors trigger less frequently during the respective half cycles when the battery is fully charged.

FIG. 4 illustrates a method 400 for controlling battery charging by the ISG. At block 402, a voltage level of a battery 116 is monitored. At block 404, an actuating signal is provided to a controllable switch in response to the voltage level of the battery being lower than a first predetermined threshold voltage. At block 406, the actuating signal that is provided to the controllable switch is stopped in response to the voltage level of the battery being greater than a second predetermined voltage. By regulating the charging of the battery 116 based on the voltage level of the battery 116, the controller 132 ensures that the voltage of the battery 116 is maintained in a predetermined range.

The present subject matter provides an efficient technique for charging the battery in an automobile including an ISG. The usage of the series regulator enables controlling the battery voltage without shunting the windings of the electrical machine. Further, since the bridge circuit is used only during the starting, and not during the charging, of the automobile, the durability and reliability of the ISG increases.

Although the present subject matter has been described with reference to specific embodiments, this description is not meant to be construed in a limiting sense. Various modifications of the disclosed embodiments, as well as alternate embodiments of the subject matter, will become apparent to persons skilled in the art upon reference to the description of the subject matter.

I/we claim:

1. An Integrated Starter-Generator (ISG) comprising:
a series regulator comprising:
a controllable switch to be connected to a terminal of an electrical machine to receive an AC voltage from the electrical machine and to be connected to a battery to supply charging current to the battery in response to actuation of the controllable switch; and
a controller connected to the controllable switch to provide an actuating signal to actuate the controllable switch, wherein the controller is configured to:
monitor a voltage level of the battery; and
determine whether to provide the actuating signal to the controllable switch based on the voltage level of the battery.

2. The ISG of claim 1, wherein
the controllable switch is a power semiconductor device,
an anode of the controllable switch is to be connected to the terminal of the electrical machine,
a cathode of the controllable switch is to be connected to a positive terminal of the battery, and
a gate of the controllable switch is connected to the controller to receive the actuating signal from the controller.

3. The ISG of claim 1, wherein the controller is to:
provide the actuating signal to the controllable switch in response to a voltage level of the battery being lower than a first predetermined threshold voltage; and
stop providing the actuating signal to the controllable switch in response to the voltage level of the battery being greater than a second predetermined threshold voltage.

4. The ISG of claim 1, wherein the controller is to provide the actuating signal to the controllable switch when an AC voltage generated at the terminal of the electrical machine is at a positive half cycle.

5. The ISG of claim 1, wherein the controller is to provide the actuating signal to the controllable switch in response to an AC voltage generated at the terminal of the electrical machine being lesser than a third predetermined threshold voltage.

6. The ISG of claim 1, wherein the controller is to regulate charging of the battery by delaying triggering of the controllable switch to control a time for which the battery is charged.

7. The ISG of claim 1, comprising a sensor system to provide signal indicative of a rotor position of the electrical machine to the controller, wherein the controller is configured to provide the actuating signal based on the signal from the sensor system.

8. The ISG of claim 1, comprising the electrical machine.

9. The ISG of claim 8, wherein the electrical machine is a three-phase electrical machine comprising a first terminal, a second terminal, and a third terminal, and wherein the series regulator comprises a first controllable switch connected to the first terminal, a second controllable switch connected to the second terminal, and a third controllable switch connected to the third terminal.

10. The ISG of claim 1, wherein the series regulator comprises a diode connected to the terminal of the electrical machine and to the controller to power the controller.

11. The ISG of claim 1, comprising:
a bridge circuit to be connected to the terminal of the electrical machine and to be connected to the battery to receive DC voltage from battery and to supply AC voltage to the terminal of the electrical machine to operate the ISG in a motoring mode.

12. The ISG of claim 11, comprising a reverse connected series diode to be connected to the bridge circuit to prevent the bridge circuit from charging the battery in a generating mode of the ISG, wherein the reverse connected series diode comprises:
an anode connected to a positive terminal of the battery; and
a cathode connected to the bridge circuit.

13. The ISG of claim 11, wherein the bridge circuit comprises a plurality of switches.

14. The ISG of claim 13 wherein the bridge circuit comprises a driver connected to each of the plurality of switches to control switching of the plurality of switches.

15. A method for controlling charging of a battery by an Integrated Starter-Generator (ISG) comprising:
monitoring a voltage level of the battery;
providing an actuating signal to the controllable switch in response to the voltage level of the battery being lower than a first predetermined threshold voltage; and
stopping to provide the actuating signal to the controllable switch in response to the voltage level of the battery being greater than a second predetermined threshold voltage.
